(19) United States
(12) Patent Application Publication
(10) Pub. No.: US 2008/0048124 A1
(43) Pub. Date: Feb. 28, 2008

(54) MULTI-MODALITY IMAGING SYSTEM

(75) Inventors: Joseph C. Pang, London (CA); Hao Lai, London (CA)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/844,021

(22) Filed: Aug. 23, 2007

Related U.S. Application Data
(60) Provisional application No. 60/823,528, filed on Aug. 25, 2006.

(51) Int. Cl. G01T 1/166

(52) U.S. Cl. 250/363.04

(57) ABSTRACT

A multi-modality imaging system is disclosed. The multi-modality system includes a Single Photon Emission Computed Tomography (SPECT) device; and a computed tomography (CT) device operatively connected to the SPECT device. A cradle is operatively connected to the SPECT device and the CT device, wherein the cradle is configured to move through the SPECT and the CT device. The cradle is configured to receive a specimen, wherein the specimen has received a plurality of radioactive isotopes. The plurality of radioactive isotopes is configured to emit a plurality of photons when the specimen is in the SPECT device. The SPECT device is configured to distinguish between the plurality of photons. The plurality of photons is utilized to generate a plurality of images relating to a plurality of compositions of the specimen.

### CROSS-REFERENCE TO RELATED APPLICATION

This application claims the benefit of U.S. Provisional Application No. 60/823,528, filed on Aug. 25, 2006.

### FIELD OF THE INVENTION

This invention relates to a multi-modality imaging system.

### BACKGROUND OF THE INVENTION

Generally, when a person is sick or suffering from some ailment the person goes to see a doctor or a medical professional to seek advice to relieve them from the ailment. This doctor or medical professional may or may not be able to help the person after examining him, but sometimes the medical professional or doctor may suggest that the person have tests done that include medical imaging. Medical imaging is a useful diagnostic tool that allows medical personnel to look non-intrusively into a living body in order to detect and assess many types of ailments, injuries, diseases and the like. This medical imaging allows doctors and medical professionals to more easily and correctly diagnose, decide on a treatment, prescribe medication, perform surgery or other treatments on a person, etc.

Several types of medical imaging devices or technology includes: magnetic resonance imaging (MRI), ultrasound, computerized axial tomography (CT) scan, single photon emission computed tomography (SPECT) and other types of tomography. These devices all have the ability to create an image of details of a bodily region of a patient (specimen) or capture the images of the specimen, for example bones, organs, tissues, blood vessels, nerves, surgical artifacts such as implants or scar tissue, etc. The actual image produced may be a two-dimensional image or a three-dimensional image.

With regard to the different types of medical imaging devices, the CAT scan operates in the following manner. When a patient lies down on a platform of the CAT scan, this platform moves through a hole in the CAT scan machine. An X-ray tube is mounted on a movable ring around the edges of a hole in the CAT scan machine. This ring also has an array of X-ray detectors directly opposite the X-ray tube. There is a motor in the CAT scan machine that turns the movable ring so that the X-ray tube and the X-ray detectors revolve around the patient's body as the platform moves. Each time the X-ray tube and X-ray detectors have a full revolution around the patient's body it scans a narrow, horizontal part or “slice” of the body. A control system of the CAT scan moves the platform farther into the hole so the X-ray tube and the X-ray detectors can scan the next slice of the patient. The CAT scan machine records X-ray slices across the patient's body in a spiral motion. After the patient's entire body is scanned and information is received, then it is sent to a computer that combines all of the information from the slices to form a detailed image of the patient. This CAT scan typically provides anatomical information about the patient or specimen when there may be a need to receive more information about the specimen.

In order to obtain more information about the specimen, a SPECT device may be utilized in conjunction with the CAT scan. The SPECT can provide information about blood flow and the distribution of radioactive substances in the body. Generally, a SPECT produces images of the body by detecting the radiation emitted from radioactive substances such as Xenon-133, Technetium-99, Iodine-123, which are injected into the specimen. Single gamma rays are emitted from the specimen while the specimen is in the SPECT device.

A multi-modality imaging system has been developed in U.S. Pat. No. 6,448,559 that utilizes both a SPECT and CT devices that allows simultaneous transmission and emission imaging of a specimen. However, this invention does not allow the user to view the body material composition for the specimen. This body material composition provides useful information to the doctor or medical professional so that he can treat the patient. Therefore, there is a need for a system that enables a user to simply determine body material composition information for the specimen.

### BRIEF SUMMARY OF THE INVENTION

The present invention has been accomplished in view of the above-mentioned technical background, and it is an object of the present invention to provide a multi-modality system that provides a user with detailed information about a specimen.

In a preferred embodiment of the invention, a multi-modality imaging system is disclosed. The multi-modality system includes a Single Photon Emission Computed Tomography (SPECT) device; and a computed tomography (CT) device operatively connected to the SPECT device. A cradle is operatively connected to the SPECT device and the CT device, wherein the cradle is configured to move through the SPECT and the CT device. The cradle is configured to receive a specimen, wherein the specimen has received a plurality of radioactive isotopes. The plurality of radioactive isotopes is configured to emit a plurality of photons when the specimen is in the SPECT device. The SPECT device is configured to distinguish between the plurality of photons. The plurality of photons is utilized to generate a plurality of images relating to a plurality of compositions of the specimen.

In another preferred embodiment of the invention, a modality imaging system is disclosed. The modality imaging system includes a Single Photon Emission Computed Tomography (SPECT) device and a cradle operatively connected to the SPECT device, where the cradle is configured to move through the SPECT device. The cradle is configured to receive a specimen, wherein the specimen has received a plurality of radioactive isotopes. The plurality of radioactive isotopes is configured to emit a plurality of photons when the specimen is in the SPECT device. The SPECT device is configured to distinguish between the plurality of photons; and the plurality of photons are utilized to separately generate a plurality of images relating to a plurality of compositions of the specimen.

In yet another embodiment of the invention, a method for utilizing the multi-modality imaging system is disclosed. A list of studies is selected. A plurality of radio-isotopes is inserted into a specimen. The specimen is transported through a Single Photon Emission Computed Tomography (SPECT) device responsive to the studies selected, wherein a plurality of photons are emitted from the specimen when in the SPECT device. The plurality of photons emitted from the specimen is captured. A plurality of images relating to a plurality of compositions of the specimen is generated responsive to the capturing of the plurality of photons emitted from the specimen.

### BRIEF DESCRIPTION OF SEVERAL VIEWS OF THE DRAWINGS

These and other advantages of the present invention will become more apparent as the following description is read in conjunction with the accompanying drawings, wherein:

FIG. 1 depicts a system overview of a SPECT-CT system in accordance with an embodiment of the invention;

FIG. 2 is a flow-chart that shows how the SPECT-CT of FIG. 1 is utilized in accordance with the invention;

FIG. 3 illustrates a SPECT in accordance with the invention;

FIG. 4 illustrates a collimator of the SPECT of FIG. 3 in accordance with the invention; and

FIG. 5 illustrates a CT of FIG. 1 in accordance with the invention.

### DETAILED DESCRIPTION OF THE INVENTION

The presently preferred embodiments of the invention are described with reference to the drawings, where like components are identified with the same numerals. The descriptions of the preferred embodiments are exemplary and are not intended to limit the scope of the invention.

A SPECT (Single Photon Emission Compute Tomography) is a device that produces images of the body by detecting the radiation emitted from radioactive substances, such as Xenon-133, Technetium-9, Iodine-123 or other isotope that have a short half life (so the activity will not linger in the specimen) and emit single gamma rays. SPECT devices provide information about blood flow and distribution of radioactive substances in the body. A CAT (Computed Axial Tomography) scan or CT scan is a medical imaging technology that generates a three-dimensional image of the internal organs of a specimen based on two dimensional X-ray images taken around a single axis of rotation.

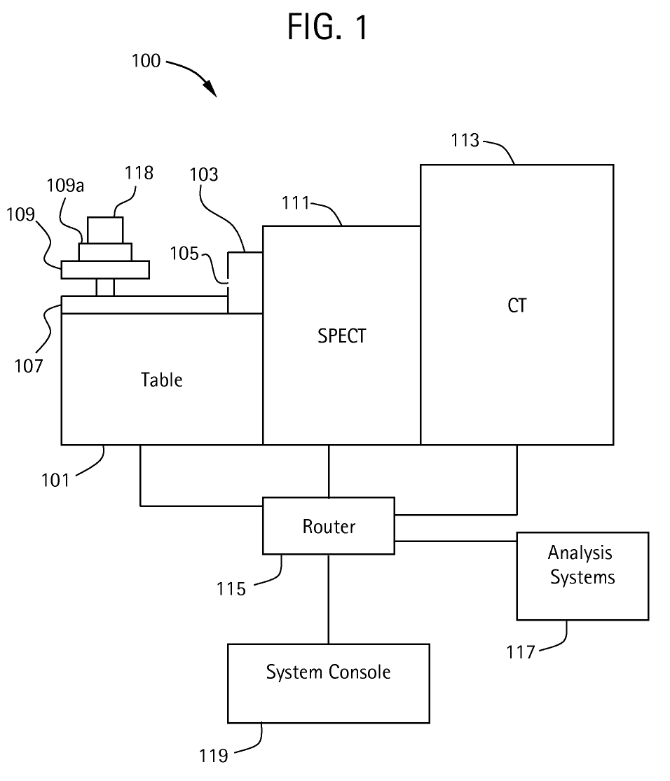

FIG. 1 is a system overview of a SPECT-CT system in accordance with an embodiment of the invention. The SPECT-CT system 100 includes: a table 101, a SPECT gantry 103, a SPECT gantry opening 105, a platform 107, a specimen holder 109, a SPECT 111, a CAT 113, a switch connector 115, an analysis station 117 and a system console 119 where all components are electrically connected to each other. A person utilizes the system console 119 to transport a specimen 118 in the specimen holder 109 across the platform 107 of the table 101 through the gantry opening 105 into the SPECT 111 and the CAT 113 or CT 113 that provides information to the system console 119 and the analysis station 117 where images of the specimen 118 would be generated. The specimen 118 may be a small animal, such as a rat or a mouse. In another embodiment of the invention, the specimen 118 may be any type of animal such as a cat, dog or even a human being. In yet another embodiment of the invention, either the SPECT 111 or the CT 113 can be respectively removed from the SPECT-CT system 100 without the operation of the system being affected. For example, for only the SPECT system this system 100 may include all of the components of SPECT-CT system except for the CT device 113. In another example, for only the CT system this system 100 may include all of the components of the system 100 except for the SPECT device 111.

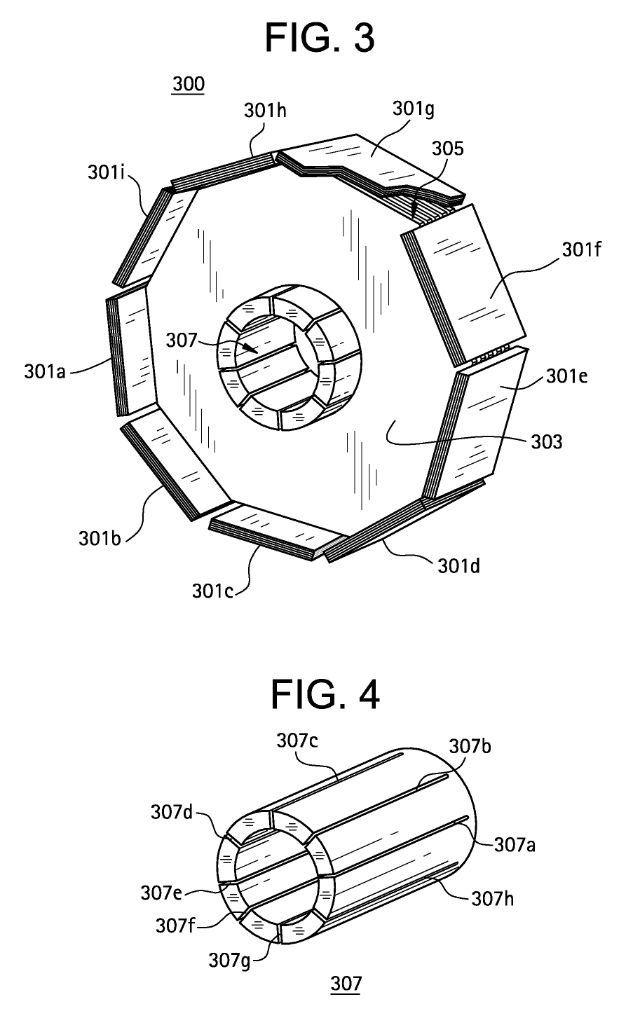

The SPECT gantry 103 of the SPECT 111 is a stationary device with a rotating collimator 307 (FIG. 3). SPECT gantry 103 is utilized to mechanically support the septa 305, detector panels 301a-j, a cooling system (not shown) and the collimator 307. Gantry opening 105 may also be referred to as a bore opening that has a diameter in the range of 20-90 mm depending on whether a mouse or rat is being transported on a cradle 109a of the specimen holder 109 through the gantry opening 105 into the SPECT-CT system 100. The cradle 109a is a user-replaceable component. Cradle 109a is available in various sizes to support animals, such as mice, rats and other animals. In another embodiment of the invention, if a human being is being transported on the cradle 109a through the gantry opening 105 then the gantry opening 105 will reflect the size of the average diameter of a human being in the range of 1-5 foot diameter.

Next to the gantry opening 105 is the SPECT 111. FIG. 3 illustrates the SPECT 111 which includes: a plurality of detector panels 301a-j, a septa 305 formed by tungsten plates, and a collimator 307. A detector ring 303 is formed by the detector panels 301a-j around the specimen 118. Detector panels 301a-j, septa 305 and the collimator 307 act as a gamma camera that detects and captures the gamma ray emissions emitted by the radioactive isotopes from the specimen 118, as the specimen travels through the SPECT 111, then the SPECT 111 through the switch connector or router 115 transmits these gamma ray emissions to the analysis station 117 and/or system console 119 where images of the specimen 118 are reconstructed based on the algorithms or equations and the received gamma ray emissions. Router 115 acts as a typical router that is a computer networking device that forwards data packets across a network toward their destinations, through a process known as routing. When the specimen 118 with the radioactive isotopes are in the SPECT 111 the radioactive isotopes emit photon energy from 27 keV to 250 keV (kilo electron volt). The radioactive isotopes utilized include Iodine, Thallium, Cobalt, Technetium, Iodine, Indium and other types of radioactive isotopes that have a gamma ray energy or emit photon energy in the range of 27 keV to 250 keV. For example, Iodine emits gamma energy of 27 keV for a half life of 60 days, Thalium emits gamma energy of 69 to 81 keV for a half-life of 73.1 hours, Cobalt emits gamma energy of 122 keV for a half-life of 270.9 days, Technetium emits gamma energy of 140 keV for a half-life of 6 hours, Iodine emits gamma energy of 159 keV for a half life of 13.2 hours and Indium emits gamma ray energy of 247 keV for a half-life of 2.8 days. These gamma ray emissions are utilized to attain functional information about the specimen at the analysis station 117 and/or system console 119. The SPECT-CT system 100 is capable of performing dual isotope data acquisition and imaging simultaneously. Dual isotope data acquisition and imaging occurring simultaneously may be referred to as dual energy, which refers to the creation of multiple images simultaneously based on to two or more radioactive isotopes injected simultaneously into the specimen 118. Dual energy provides for tissue/body composition of the specimen 118. This dual energy method takes advantage of the fact that different radioactive isotopes emit photons at different energies, and the detector 301a-j or CZT detectors can distinguish among those at detection, where each isotope emits its own gamma ray energy in the specimen 118 at the same time. The SPECT data acquisition system, described below, is capable of distinguishing which isotope contributes to the events from the received gamma ray energies and then bins these events separately. After the image is reconstructed, the images with two isotope distributions in the specimen 118 can be obtained.

Detector panels 301a-j are utilized to detect the gamma ray emissions or gamma ray photon emitted by the radioactive isotopes in the specimen. The detector panels 301a-j are composed of 10 typical gamma ray detector panels placed around the septa 305. Preferably, the ten detector panels are made of Cadium Zinc Telluride (CZT) that are utilized to form an array of 2×2 (dual ring) or 1×2 (single ring) detector module. These detector modules are currently made by Imarad, which is a 256 channel (16×16 pixels) CZT gamma radiation detector. This CZT detector module has the following features: 2.46 mm pixel size, 0.6 mm gap between pixels, support gamma ray energy up to 200 keV, typical energy resolution is 6% at 140 keV, Bias voltage −600V to about −800 v, Energy threshold level 0-200 mV (0-200 keV) and energy analog output 0-355 μA (0-200 keV). These 10 detector panels may be made by any manufacturer of CZT detector panels known to those of ordinary skill in the art. The detector panels 301a-j can be modular (separate panels) or a nearly continuous ring, which includes tiled flat panels or even curved detector surfaces (e.g., NaI annulus). This continuous ring can be complete (360°) or a smaller fraction, although unbiased reconstruction requires at least a half-ring (180°). This continuous ring may not be circular. The ring can be an elliptical ring or it could be contoured to the body profile of individual subjects. The detector panels 301a-j are utilized to form the detector ring 303.

Within the detector ring 303 is the septa 305, which are 2 to 50 dividing walls that are thin parallel sheets that have a thickness of 0.2 mm and height in a range of 65-70 mm. Preferably, there are 31 parallel sheets used in the septa 305. These parallel sheets of septa 305 are made of metal, such as tungsten and are known as tungsten plates. The tungsten plates of septa 305 are separated by each other at a distance in the range of 1 to 5 millimeters. Preferably, the tungsten plates of septa 305 are placed 2.46 mm apart from each other. The spacing of the tungsten plates is aligned to the CZT detector pixels, where each tungsten sheet is aligned in the dead space between two adjacent detector pixels. Septa 305 is stationary and is used to define the trans-axial slices of the specimen. A center portion of septa 305 must be able to accommodate a large collimator. In another embodiment of the invention, the septa 305 include Rohacell spacer rings by the center portion of the tungsten plates. These Rohacell spacers are used to sandwich the tungsten plates to form the entire septa 305.

Located below septa 305 is a collimator 307. Referring to FIG. 4, the collimator 307 is shown. This multi-slit collimator 307 rotates around the specimen to define in-slice information about the specimen and transmits it through the router 115 to the analysis station 117 and the system console 119. Also, this collimator 307 is utilized for whole body imaging of the specimen due to the longitudinal nature of slits 307a-h which allows photons from a large area to be passed to the detectors 301a-j. In another embodiment, several types of collimator 307 are utilized, which include a multi-pin hole collimator and a combination multi-slit collimator and multi-pin hole collimator. For the multi-slit collimator 307, there are three different types of slits utilized depending on the specimen (animal) and the purpose of utilizing the collimator 307. If the purpose for utilizing the multi-slit collimator 307 is for obtaining a high resolution of a mouse specimen, then the following characteristics for the collimator 307 apply: material-tungsten, inner diameter-10-50 mm, wall thickness 5-10 mm, slit angle 30-70 degrees, aperture 0.10-2.0 mm, number of slits 1-8, Field of view 2.0-50 mm, spatial resolution in plane 0.30-5 mm, axial spatial resolution 2.00-3.14 and sensitivity 0.001-0.30%. However, if the purpose for utilizing the multi-slit collimator 307 is for obtaining a general purpose for a mouse specimen, then the following characteristics apply: material-tungsten, inner diameter-50-100 mm, wall thickness 1-50 mm, slit angle 5-30 degrees, aperture 0.2-5 mm, number of slits 20-30, Field of view (FOV) 1-6 cm, spatial resolution in plane 1.0-5 mm, axial spatial resolution 2-4 and sensitivity 0.02%-0.50%. In another embodiment, if the purpose for utilizing the multi-slit collimator 307 is for the a general purpose of obtaining a rat specimen, then the following characteristics for the collimator 307 apply: material-tungsten, inner diameter-80-90.5 mm, wall thickness 5-20 mm, slit angle 50-90 degrees, aperture 0.6-3.0 mm, number of slits 2-8, FOV 8 cm, spatial resolution in plane 1-5 mm, axial spatial resolution 2.5-3.14 and sensitivity 0.02%-0.10%.

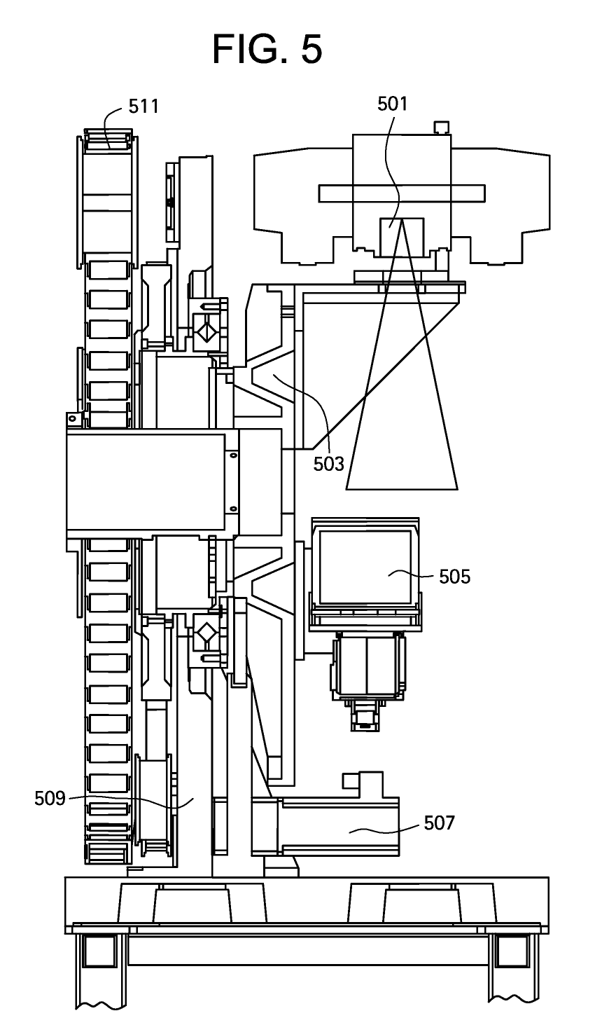

Next to the SPECT 111 is the CT 113 as shown in FIG. 5. CT 113 includes the following components: X-ray tube 501, rotating disc 503, detector 505, servo-driving system 507, casting support 509, cable routing system and the typical components associated with a CT scan. During normal operation, the specimen 118 is inserted through the gantry opening 105 through the SPECT 111 into the CT 113, where the specimen would go through the scan plane that is supported by the casting support 509. Preferably, the casting support 509 would be made of aluminum. Casting support 509 also supports the detector 505 or X-ray detector 505 which is directly opposite from the X-ray tube 501.

A cable routing system 511 or cable chain 511 is next to the casting support 509. This cable routing system 511 works in conjunction with the specimen holder 109, the casting support 509 and the servo driving system 507 to manage the cables to allow the CT gantry to rotate around the specimen 118. This cable routing system 511 may also be known as a helical scan cable routing system, which manages the cable to allow the CT gantry to rotate 1-5 times around the specimen. Preferably, the CT gantry rotates 3.5 turns around the specimen. Cable routing system 511 rotates around the specimen in a 360 degree motion. This cable routing system 511 includes a protection mechanism that prevents the cable routing system 511 from over-rotation to protect the cabling and chains of the cable routing system 511. The protection mechanism has the following features: slow down the rotation for the last half turn; optical switch controlled by software to stop the rotation of CT 113 and an electrical switch to cut off the power to prevent the cable routing system 511 from over-rotation if the optical switch or software failed at the analysis station 117 or system console 119.

The X-ray tube 501 and detector 505 revolves around the specimen. The X-ray tube 501 may also be referred to as an X-ray generator. For this embodiment, there are two types of X-ray generators. The first type of X-ray generator is the X-ray tube for the lower level CT system 113, which include the following features: KVP range 35-80 kVp; μA range of 20-1000 μA; focal spot 50 μm; Duty cycle 50%, 5 HZ, 100 CFM of air flow over unit required; and Rise time, (kVp): Less than 10 mS measured from 10% to 90% waveform. Preferably, the first type of X-ray tube is made by Source-Ray, Inc. The second type of X-ray generator is an X-ray tube for the high tier CT 113 system which has the following features: KVP Range; 35-150 kVP; Current range: 16 mA max; Anode speed: 9000 RPM; Focal spot: 300 μm; and a Target angle: 10°. Preferably, the second type of X-ray tube would be made by a manufacturer by the name of Dunlee. This high tier CT 113 system should be able to support pulsed gating at 14 ms. Gating refers to: a) recording the times of occurrence of each cardiac cycle of the specimen simultaneously with the raw image data of the specimen (i.e. photon detection events), and b) using this timing record to re-sort and reconstruct the collected raw image data of the specimen to produce one to several images, each at successive phases in the cardiac cycle. The cardiac analysis tool measures heart dimensions at various phases in the cardiac cycle, and calculates the various cardiac functional measures, as is current clinical practice by utilizing clinical application software product stored on the system console 119 and/or analysis station. The high tier X-ray tube is more efficient then the low tier X-ray tube, because the high tier X-ray tube supports cardiac gating and dual energy imaging.

Each full revolution of the CT gantry around the specimen is a narrow portion or a horizontal “slice” of the specimen's body is scanned. For the CT 113, there is a dual energy method that refers to the use of two or more distinct x-ray beam mean energies to produce two or more images that show information on mean material atomic number, for example tissue composition. With regard to the two energies for the high end tube for CT, it means the x-ray tube can be operated at two X-Ray energies, more precisely two different voltage kVp, say 80 kV or 120 kV. By imaging an object at two kVP (usually combining with different filtering), more detailed anatomic information can be revealed. This application requires the x-ray tube to switch these two voltages very quickly.

A control system (not shown) of the SPECT-CT system 100 connected (wirelessly or electrically) to the specimen holder 119 moves the specimen farther into the gantry opening 105 or the hole so the X-ray tube 501 and detectors 505 can scan the next slice of the specimen. The detector 505 may be referred to as an X-ray detector that includes a scintillator, an optical taper and a Charge Couple Device (CCD) camera. Preferably, the scintillator is made of cesium iodide that converts the X-ray to visible light and then guided by an optical taper, which concentrates the light on to the CCD camera. Preferably, the CCD camera is a Carmelia Atmel 8 M CCD camera. This Carmelia CCD camera is a full frame sensor that must use either a shutter or a pulsed lighting in front of the camera in order to have incident lighting on the CCD camera only during integration time. The Carmelia Atmel 8 M CCD camera has the following key parameters: 3500×2300 with 10 μm Square Pixels; 35 mm×25 mm active area; Readout time: 110 ms (4×4 pixel binning, 2.67 f/s max); 200 ms (2×2 binning, 4.91 f/s max), 370 nm (non binning, 8.82 f/s max); flexible and easy to operate via RS-232 Control; Trigger Mode: free-run or external trigger modes; Φ 125 optical taper with ration 3: and Screen size 107 mm×70 mm. The detector 505 records all the X-ray slices across the body of the specimen in a spiral motion as information, then this information is transferred to the analysis station 117 or system console 119. The analysis station 117 or system console 119 varies the intensity of the X-rays in order to scan each type of tissue with the optimum power.

Referring to FIG. 1, system console 119 is a typical computer or workstation, such as a personal digital assistant (PDA), laptop computer, notebook computer, media player, mobile telephone, hard-drive based device or any device that can receive, send and store information. Analysis station 117 is equivalent to system console 119. The system console 119 and analysis station 117 are typical computers that include a processor, an input/output (I/O) controller, a mass storage, a memory, an input device, a display, a video adapter, a connection interface and a system bus that operatively, electrically or wirelessly, couples the aforementioned systems components to the processor. Also, the system bus electrically or wirelessly, operatively couples typical computer system components to the processor. The processor may be referred to as a processing unit, a central processing unit (CPU), a plurality of processing units or a parallel processing unit. The CPU includes standard and user defined protocols that provide flexibility in combining SPECT 111 and/or CT 113 scans in any combination and sequence to make a hybrid exam. System console 119 has the options to view the images received from the SPECT 111 or CT 113 separately and has capability of fusing the images from the SPECT 111 and CT 113. The amount of error between the two automatically registered datasets shall be less than 0.1 mm. The image fusion may be done by any typical image fusion software program. Preferably, the image fusion will be done by MicroView software program. By utilizing MicroView users can load multiple volumes, and manually or automatically register the volumes, by selecting the position of the same points in different volumes. Also, the users can save the information matrix, so that they can reload the defined transformation matrix when they need to study the volume again. System bus may be a typical bus associated with a conventional computer. Memory includes a read only memory (ROM) and a random access memory (RAM). ROM includes a typical input/output system including basic routines, which assists in transferring information between components of the computer during start-up. The typical input devices or graphical user interface (GUI) utilized are keyboards, joysticks, mouse, game pads or the like. Also, the user interface should have the following functions: primary user interface GUI, interface reconstruction, scan request control, data acquisition control, calibration and service. A display is electrically or wirelessly connected to the system bus by the video adapter. The display may be the typical computer monitor, television, Liquid Crystal Display (LCD), High-Definition TV (HDTV), projection screen or a device capable of showing characters and/or still images generated by a computer.

The mass storage of system console 119 and analysis station 117 includes: 1. a hard disk drive component (not shown) for reading from and writing to a hard disk and a hard disk drive interface (not shown), 2. a magnetic disk drive (not shown) and a hard disk drive interface (not shown) and 3. an optical disk drive (not shown) for reading from or writing to a removable optical disk such as a CD-ROM or other optical media and an optical disk drive interface (not shown). The aforementioned drives and their associated computer readable media provide non-volatile storage of computer-readable instructions, data structures, program modules and other data for the system console 119. Also, the aforementioned drives include the software program or algorithm that controls the operation of the SPECT-CT system 100. In another embodiment, the software program or algorithm has a technical effect that controls the operation of the SPECT-CT system may be stored in the processor or memory of the system console 119 or any other part of the system console 119 known to those of ordinary skill in the art.

The mass storage system of system console 119 includes the software requirements for the SPECT 111. Specifically, the software requirements include a DATA Acquisition control component, Stationary Controller component and Image Reconstruction component. For the DATA Acquisition control there are design requirements for the SPECT data acquisition system and code to communicate with the detector panels 301a-j. The design requirements for the SPECT 111 data acquisition system are: sampling rate≧200 kcps (kilocounts per second), continuous collimator motion in a constant speed, support for constant count mode, Helical scan capability, Real-time synchronization with physiological inputs and support for the system configuration with single and dual detector rings. The system console 119 communicates with the detector panels 301a-j or CZT modules by utilizing a specialized code. Preferably, the code is a LabView code that acquires event data including energy, address, encoder and gating signals etc. The basic functions for the LabView code are the following: communication with LabView to control data acquisition hardware, transfer data from Data acquisition system and re-framing data structure (list mode), data processing and pre-correction, and display total events counts and instantaneous event counts.

For the Stationary Controller component of the software, the design goals for the system are as follows: shared table control of table 107 (table 107 must be synchronized with both SPECT 111 and X-ray CT 113), temperature control, Gigabit of faster Ethernet communication to Recon and power distribution unit control and monitoring. The Image reconstruction component is a SPECT 111 reconstruction algorithm and software. This software may have both analytical and iterative reconstruction engines. The reconstructed images may be corrected based on the following different types of corrections: CT measured attenuation correction, detector sensitivity correction, detector uniformity correction, system geometry correction, scattering correction, Isotope physical decay correction, resolution recovery (in both axial and transaxial directions) and partial volume correction. Further, the software requirements includes the clinical application software product entitled, “Quantitative GATED SPECT” software program or the Cedars Sinai Quantitative Gated SPECT (QGS) option that enables automated processing of myocardial perfusion SPECT and gated SPECT data. This software provides left ventricular ejection fraction calculations, 3D beading image displays, volume curves and polar maps.

Also, the mass storage system of system console 119 includes the software requirements for the CT 113. Specifically, the software requirements include a Data Acquisition control, Corrections, Image Reconstruction, Image stitching, Calculation, and clinical application software. For Data Acquisition, the same software for the Locus CT system manufactured by GE Healthcare will be utilized. However, this data acquisition will also include helical scan capability and real-time synchronization with physiological inputs for gating.

The Corrections aspect of the software requirements includes: ring artifact correction, beam hardening improvements and scattering correction. The beam hardening improvements include filters the high tier CT 113 system and software correction. The scattering correction is applied to bright/dark and bad pixel map for reconstruction.

For the Image reconstruction, the reconstruction system uses a 64-bit processing time. Also, there is a recon query for multiple reconstructions for offline batch reconstructions. Next, there is image stitching or putting the images together for the CT scans relative to the low tier CT system and the high tier CT system. For the low tier CT system to achieve 100 mm axial FOV, two scans at two bed positions will be taken. The two images from these two scans need to be stitched together to realize 100 mm FOV. For the high tier CT system to achieve 200 mm axial FOV, two helical scans will also be required since one helical scan can only achieve 110 mm axial FOV. These two images from these two helical scans also need to be stitched together. The last aspect of the software requirements for CT is the calculation which includes two points: software should be able to automatically calculate ejection fraction (EF), stroke volume (SV) and cardiac output (CO); and the software is able to assess the image quality with phantom and automatically provide quantitative results. Also, there are software products for kidney performance, lung performance, brain performance or any major organ performance. For example, for lung performance the Lung Vcar (Volume computer-assisted reading) software program may be utilized to visualize the lungs of the specimen. The Lung VCAR is the first application package designed specifically for volume CT imaging. Its volume computer-assisted reading (VCAR) performance addresses the challenges associated with lung nodule diagnostics.

For the analysis station 117, next to the system console 119, the hard drive, magnetic disk drive and the optical drive in the analysis station 117 include the software program or algorithm for reconstructing the SPECT image and the CT image of the specimen as described in system console 119. In another embodiment of the invention, the software program or algorithm that has a technical effect of reconstructing the SPECT image and the CT image of the specimen may be stored in the processor or memory of the analysis station 117 or any other part of the analysis station 117 known to those of ordinary skill in the art. Also, in yet another embodiment of the invention the algorithm for reconstructing the SPECT image and the CT image of the specimen may be stored in the processor, memory or mass storage component of the system console 119.

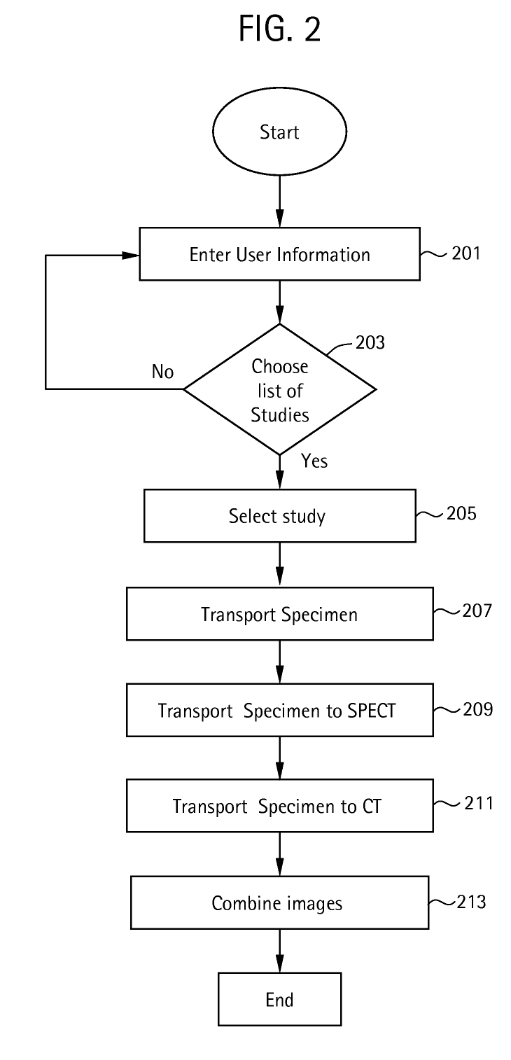

FIG. 2 depicts a flow chart of how the SPECT-CT system is employed. At block, 201a user goes to the system console 119 and inputs information, such as his user name and possible password on a keyboard of the system console 119 to begin utilizing the SPECT-CT system 100.

At block 203, the software program on the processor of the system console 119 includes a database with a list of studies that will be displayed after the user enters his or her username and password. The person must decide which study to pursue. If the person does not choose to pursue any studies, then he will use the input device to request no studies be performed and the program will return to the username and information page at block 201. The studies relate to an actual procedure that will be conducted on the specimen as it goes through the SPECT-CT system, such as a SPECT only scan of any animal, a CT only scan of an animal or a combination SPECT-CT scan of the animal. If the person does decide to pursue a study, then the process goes to block 205.

At block 205, the person would select a study that includes: a SPECT only scan of any animal, a CT only scan of any animal or a combination SPECT and CT scan of any animal. For this example, the user has chosen to do a combination SPECT-CT scan for any animal. The animal may be a mouse, rat, cat, dog or even a human being. For example, the person chooses to conduct a combination SPECT-CT scan of a mouse. At this time, the software program will provide a protocol of how the test should be conducted. In the combination SPECT-CT procedure the specimen 118 (FIG. 1) or animal will be inserted or injected with a certain amount of radioisotope (e.g. Xenon) or a plurality of radioisotope for a SPECT scan and injected with a certain amount of isotopes or contrast agents for the CT scan depending on the requirements of the study. This software program includes a database that corresponds with different types of animals, their respective SPECT scan or CT scan, radioisotope to be utilized, how much radioisotope to be utilized, the duration of the isotope and other coordinating information.

At block 207, the user places the specimen 118 onto the specimen holder 109 and the user utilizes a touch screen or another input device on the system console 119 to instruct a motor controller (not shown) in the table 101 to force the specimen holder 109 to transport the specimen through the gantry opening 105 of the SPECT gantry 103. Specimen holder 109 includes a cradle 109a where the specimen can be held in place as it is being transported across the platform 107 into the SPECT 111. While the mice or rat is in the cradle 109a the mouse or the rat is sedated by a typical anesthetic solution utilized to anesthetize a mouse or rat. In another embodiment, if a human being is in the cradle 109a then the human may or not be anesthetized when he is transported through the SPECT-CT system 100.

Next, at block 209 the specimen 118 goes through the gantry opening 105 into the SPECT 111 (FIG. 3). As stated above, the detector panels 301a-j, detector ring 303, septa 305 and the collimator 307 act as a gamma camera that detects and captures the plurality of photons or gamma ray emissions emitted by the radioactive isotopes from the specimen 118, as the specimen 118 travels through the SPECT 111, then the SPECT 111 through the router 115 transmits these gamma ray emissions to the analysis station 117 and/or system console 119 where images of the specimen are reconstructed based on the algorithms or equations and the received gamma ray emissions. In another embodiment, the radioactive isotopes may be referred to as a radio pharmaceutical isotopes or tracer isotopes. When the specimen 118 with the radioactive isotopes are in the SPECT 111 the radioactive isotopes may emit photon energy, for example in the range of 27 keV to 250 keV (kilo electron volt). The radioactive isotopes utilized include Iodine, Thallium, Cobalt, Technetium, Iodine, Indium and other types of radioactive isotopes that have a gamma ray energy or emit photon energy that are disclosed above. These gamma ray emissions are utilized to attain functional information about the specimen at the analysis station 117 and/or system console 119.

Within septa 305 is a collimator 307 (FIG. 4), which is a multi-slit collimator 307 that rotates around the specimen to define in-slice information about the specimen 118 and transmits it through the router 115 to the analysis station 117 and the system console 119. Also, this collimator 307 is utilized for whole body imaging of the specimen 118 due to the longitudinal nature of slits 307a-h which allows photons from a large area to be passed to the detectors 305. Several types of collimators 307, as disclosed above, may be utilized, such as the multi-pinhole collimator.

Next, at block 211 the specimen leaves the SPECT 111 and enters the CT scan 113 (FIG. 5). A control system of the SPECT-CT system 100 forces the specimen holder 119 to move the specimen 118 farther into the hole so the X-ray tube 501 and detectors 505 can scan at least one slice or slices or X-ray slices of the specimen. The detector 505 records all the X-ray slices across the body of the specimen in a spiral motion as information, then this information is transferred to the analysis station 117 or system console 119. The analysis station 117 or system console 119 varies the intensity of the X-rays in order to scan each type of issue with the optimum power. At block 213, after the specimen passes through the CT 113, the analysis station 117 or system console 119 will automatically fuse or combine all the information of at least one slice or slices or X-ray slices of the specimen from the CT 113 and the generated plurality of images relating to the plurality of compositions of the specimen from the SPECT 111, by utilizing the software program described above, from each scan to form one or a plurality of detailed image of the specimen body showing at least one slice of the specimen with a plurality of compositions or tissue, then this process ends.

This invention provides a SPECT-CT system that allows a user to determine the anatomical and functional aspects of a specimen by fusing the SPECT and CT image. Also, this SPECT-CT system enables the user to obtain dual isotope acquisition for the SPECT and CT allows for dual energy imaging of the specimen where the detector in the SPECT can distinguish between the two different photons emitted from the specimen as it passes through the SPECT-CT. CT provides images using a dual energy method. These dual energy images provide a body or tissue decomposition of the specimen.

It is intended that the foregoing detailed description of the invention be regarded as illustrative rather than limiting and that it be understood that it is the following claims, including all equivalents, which are intended to define the scope of the invention.

What is claimed is:

1. A multi-modality imaging system, comprising:
a Single Photon Emission Computed Tomography (SPECT) device;
a computed tomography (CT) device operatively connected to the SPECT device; a cradle operatively connected to the SPECT and the CT device, wherein the cradle is configured to move through the SPECT and the CT device;
wherein the cradle is configured to receive a specimen, wherein the specimen has received a plurality of radioactive isotopes;
wherein the plurality of radioactive isotopes are configured to emit a plurality of photons when the specimen is in the SPECT device;
the SPECT device is configured to distinguish between the plurality of photons; and
wherein the plurality of photons are utilized to generate a plurality of images relating to a plurality of compositions of the specimen.

2. The multi-modality imaging system of claim 1, wherein the plurality of photons are a plurality of gamma ray emissions.

3. The multi-modality imaging system of claim 2, wherein the specimen has received the plurality of radioactive isotopes by an injection.

4. The multi-modality imaging system of claim 1, wherein the plurality of images are generated by a reconstruction algorithm.

5. The multi-modality imaging system of claim 4, wherein a system console is coupled to the SPECT device and the CT device where the system console includes the reconstruction algorithm.

6. The multi-modality imaging system of claim 5, wherein the system console is coupled by a connection device to the SPECT.

7. The multi-modality imaging system of claim 6, wherein the connection device is a router.

8. The multi-modality imaging system of claim 9, wherein the plurality of radioactive isotopes are from the group comprising Iodine, Thallium, Cobalt, Technetium, Iodine and Indium.

9. The multi-modality imaging system of claim 1, wherein the SPECT device includes a plurality of detector panels.

10. The multi-modality imaging system of claim 9, wherein the plurality of detector panels are Cadium Zinc Telluride (CZT) detector modules.

11. The multi-modality imaging system of claim 10, wherein the CZT detector is configured to distinguish between the plurality of photons emitted from the specimen.

12. The multi-modality imaging system of claim 5, wherein the system console is from the group comprising a personal digital assistant, media player, mobile telephone, computer or laptop computer.

13. The multi-modality imaging system of claim 1, wherein the SPECT device includes a septa.

14. The multi-modality imaging system of claim 13, wherein the septa comprises a plurality of dividing walls.

15. The multi-modality imaging system of claim 14, wherein the plurality of dividing walls are made of metal.

16. The multi-modality imaging system of claim 13, wherein the septa is configured to define trans-axial slices of the specimen.

17. The multi-modality imaging system of claim 13, wherein the septa includes Rohacell spacers.

18. The multi-modality imaging system of claim 1, wherein the CT comprises an X-ray detector.

19. The multi-modality imaging system of claim 18, wherein the X-ray detector includes a scintillator, an optical taper and a Charge Coupled Device (CCD) camera.

20. The multi-modality imaging system of claim 19, wherein the CCD camera is a Carmelia Atmel camera.

21. The multi-modality imaging system of claim 5, wherein the system console is configured to generate automated processing of the specimen myocardial perfusion.

22. The multi-modality imaging system of claim 1, wherein the CT is configured to scan at least one slice of the specimen and records this information.

23. The multi-modality imaging system of claim 22, wherein the CT is configured to transfer the at least one slice of the specimen to an analysis station.

24. The multi-modality imaging system of claim 23, wherein the SPECT is configured to transfer the generated plurality of images relating to the plurality of compositions of the specimen to the analysis station.

25. The multi-modality imaging system of claim 24, wherein the analysis station is configured to combine the at least one slice of the specimen information and the generated plurality of images relating to the plurality of compositions of the specimen to form at least one image of the specimen.

26. A modality imaging system comprising:
a Single Photon Emission Computed Tomography (SPECT) device;
a cradle operatively connected to the SPECT device, wherein the cradle is configured to move through the SPECT device;
wherein the cradle is configured to receive a specimen, wherein the specimen has received a plurality of radioactive isotopes;
wherein the plurality of radioactive isotopes are configured to emit a plurality of photons when the specimen is in the SPECT device;
the SPECT device is configured to distinguish between the plurality of photons; and
wherein the plurality of photons are utilized to generate a plurality of images relating to a plurality of compositions of the specimen.

27. A method for utilizing a multi-modality system, comprising:
selecting a list of studies;
inserting a plurality of radioisotopes into a specimen;
transporting the specimen through a Single Photon Emission Computed Tomography (SPECT) device responsive to the studies selected, wherein a plurality of photons are emitted from the specimen when in the SPECT device;
capturing the plurality of photons emitted from the specimen; and
generating a plurality of images relating to a plurality of compositions of the specimen responsive to capturing the plurality of photons emitted from the specimen.

28. The method of claim 27, wherein the plurality of photons are gamma ray emissions.

29. The method of claim 27, wherein the plurality of radioisotopes are radio pharmaceutical isotopes.

30. The method of claim 27, wherein the plurality of radioisotopes are tracer isotopes.

31. The method of claim 27, wherein the plurality of photon has an energy level in a range of 27 keV to 250 keV.

32. The method of claim 27, wherein the plurality of images are generated at a system console.

33. The method of claim 27, further comprising:
transferring the specimen to scan a plurality of slices of the specimen.

34. The method of claim 33, further comprising:
recording all the plurality of slices of the specimen across a body of the specimen as information.

35. The method of claim 34, wherein the plurality of slices are X-ray slices.

36. The method of claim 35, wherein the record of all the X-ray slices across the body are recorded in a spiral motion.

37. The method of claim 36, further comprising:
transferring the X-ray slice information.

38. The method of claim 37, wherein the X-ray slice information is transferred to a system console.
